(19) United States
(12) Patent Application Publication
(10) Pub. No.: US 2026/0274217 A1
(43) Pub. Date: Sep. 17, 2026

(54) Controller for an Autonomous Emergency Braking System, and Method for Controlling an Autonomous Emergency Braking System

(71) Applicant: Bayerische Motoren Werke Aktiengesellschaft, Munchen (DE)

(72) Inventor: Holger ULRICH, Muenchen (DE)

(21) Appl. No.: 19/479,767

(22) PCT Filed: Apr. 9, 2024
(86) PCT No.: PCT/EP2024/059590

§ 371 Date: Oct. 29, 2025

(30) Foreign Application Priority Data
Jun. 16, 2023 (DE) 10 2023 115 808.2

(51) Int. Cl. B60T 7/12

(52) U.S. Cl. CPC B60T 7/12; B60T 2220/04

(57) ABSTRACT

A controller for an autonomous emergency braking system that is configured to receive, while an automated emergency braking operation is performed, information about an actuation of an accelerator pedal of the vehicle; to determine, on the basis of the information, whether the actuation of the accelerator pedal satisfies a termination criterion; and to terminate the emergency braking operation if the actuation of the accelerator pedal satisfies a termination criterion. In the process, a first termination criterion is used as termination criterion if a speed limiter of the vehicle is not active. However, if the speed limiter is active, a second termination criterion is used which differs from the a first termination criterion.

### BACKGROUND AND SUMMARY

The invention relates to a controller for an autonomous emergency braking system and to a method for controlling an autonomous emergency braking system. Furthermore, the invention relates to a computer program for carrying out such a method and to a computer-readable storage medium on which such a computer program is stored.

Modern motor vehicles are often equipped with an autonomous emergency braking system, which can also be referred to as an emergency braking assistant or AEB (autonomous emergency braking) system. Autonomous emergency braking systems generally use sensors to determine distances to objects or obstacles, and also accelerations, steering angles, steering wheel angles, and pedal positions. It is calculated on this basis whether a critical situation exists which makes braking necessary, for example to prevent a collision with a preceding vehicle or at least to reduce the severity of an unavoidable impact. If the driver themselves does not react in a timely manner in such a situation, the autonomous emergency braking system brakes the vehicle automatically.

An autonomous emergency braking action can normally be overridden by an active intervention of the driver who is still responsible for the vehicle control. This is important above all if the autonomous emergency braking function brakes incorrectly. To check whether the conditions for an override of an autonomous emergency braking action exist, the steering angle, the brake pedal actuation, and the accelerator pedal actuation are typically evaluated. For example, the autonomous emergency braking action can be overridden by steering or giving gas. Furthermore, it can be provided that the autonomous emergency braking action is aborted if the driver initially brakes and then no longer brakes. With respect to the accelerator pedal actuation, for example, a predefined accelerator pedal angle change, an absolute accelerator pedal angle, or a combination of the two can be used as an abort criterion for the autonomous emergency braking action.

Another driver assistant system which is present in many modern motor vehicles is a speed limiter, which can also be referred to as a speed limit device (SLD). A speed limiter assists the driver in this case in not exceeding a self-selected limit speed and thus provides a contribution to improved driving comfort and to enhanced traffic safety. In addition to manual adjustability of a limit speed, in advanced systems, there is also the possibility of automatic adoption of a speed limit applicable in a currently traveled road section from digital map information and/or on the basis of a camera-based traffic sign recognition.

Similarly as in a conventional cruise control, the speed limiter function engages in the engine and transmission control to reduce the engine torque requested by the driver before exceeding the set limit speed. There is always the possibility in this case that the driver will override the limit to the limit speed, for example in that they depress the accelerator pedal completely or almost completely. The limit is thereupon canceled. As a result, driving above the limit speed is also possible as usual; the driver also does not have to permanently maintain the large accelerator pedal angle for this purpose (i.e. the accelerator pedal position depressed comparatively far), which they have set to override the speed limiter.

If a vehicle drives with an active speed limiter, depending on the design, the accelerator pedal angle can be very high and can be, for example, up to 95% of a maximum settable accelerator pedal angle (i.e. an accelerator pedal angle in the state of the accelerator pedal which is fully depressed), without the vehicle accelerating further. The speed is thus limited in spite of the almost completely depressed accelerator pedal. If an emergency braking action takes place in this situation and the driver still depresses the accelerator pedal, an immediate abort of the emergency braking action can inadvertently occur if the accelerator pedal angle is so high that the threshold for aborting the emergency braking action is reached.

Proceeding therefrom, it is an object of the present invention to specify a controller for an autonomous emergency braking system and a method for controlling an autonomous emergency braking system which implement an improved override scheme for the emergency braking function with simultaneously activated speed limiter.

This object is achieved by the subject matter disclosed herein. Advantageous embodiments are also specified in the present disclosure.

A first aspect of the invention relates to a controller for an autonomous emergency braking system of a vehicle.

The vehicle can in particular be a motor vehicle. The term motor vehicle is to be understood here in particular as a land vehicle moved by machine power, without being bound to tracks. A motor vehicle in this sense can be designed, for example, as a passenger vehicle, motorcycle, or tractor.

The controller is configured to receive information about an actuation of an accelerator pedal of the vehicle while an automatic emergency braking action is executed by the autonomous emergency braking system.

An accelerator pedal is to be understood here as a pedal using which a drive power of the vehicle is settable, thus, for example, a gas pedal in a vehicle having internal combustion engine or a power pedal in an electrically driven vehicle.

The information about the actuation of the accelerator pedal can in particular comprise information about whether and possibly how far the accelerator pedal is depressed. For example, the information about the actuations of the accelerator pedal can comprise a set accelerator pedal angle.

When reference is made hereinafter to an accelerator pedal angle, this is to be understood as an accelerator pedal angle which is defined so that it becomes larger with increasingly depressed accelerator pedal. For example, the accelerator pedal angle can be defined so that in an idle position of the accelerator pedal (thus with non-actuated accelerator pedal) it can be zero and when the accelerator pedal is depressed to a maximally depressed accelerator pedal position, it increases to a maximum settable accelerator pedal angle.

The respective current accelerator pedal angle can be detected, for example, in a way known per se by an accelerator pedal angle sensor. The accelerator pedal angle sensor can be connected for signaling to the controller in order to provide it with information about the respective current accelerator pedal angle.

The controller is furthermore configured to establish on the basis of the information whether the actuation of the accelerator pedal meets an abort criterion and to abort the emergency braking action depending on whether the actuation of the accelerator pedal meets the abort criterion.

It is thus to be possible to override the emergency braking action by an actuation of the accelerator pedal which meets the abort criterion. It is to be understood here that meeting the abort criterion with respect to the accelerator pedal actuation can, according to some embodiments, only be a necessary, but not a sufficient condition for aborting the emergency braking action. Further abort criteria can be added, such as a detected steering actuation and/or a detected brake pedal actuation, which according to some embodiments also have to be met so that the controller generates a control signal to abort the emergency braking action.

According to the invention, it is now provided that a first abort criterion is used as the abort criterion for the emergency braking action which is related to the actuation of the accelerator pedal if a speed limiter of the vehicle is not active and that a second abort criterion, which is different from the first abort criterion, is used if the speed limiter of the vehicle is active.

The speed limiter being active in this context means that the vehicle drives in the limiter, thus that the speed limiter is actually active in that the speed of the vehicle is not increased above the limit speed of the speed limiter due to the speed limiter in spite of a present accelerator pedal actuation. The invention thus provides that a pedal actuation necessary to override the emergency braking function with active speed limiter differs from a pedal actuation required to override the emergency braking function with inactive speed limiter.

According to one embodiment, establishing whether the first abort criterion is met comprises checking whether the accelerator pedal reaches or exceeds a first limiting accelerator pedal position. For example, it can be checked here whether the accelerator pedal is depressed to a predefined (absolute) limiting accelerator pedal angle or beyond. Reaching or exceeding the limiting accelerator pedal position can be a necessary or even a sufficient condition for meeting the first abort criterion in this case. In other words, it can be provided that the emergency braking action is aborted in the case that the speed limiter is not active if the accelerator pedal is depressed at least to the first limiting accelerator pedal position.

Analogously thereto, establishing whether the second abort criterion is met can comprise that it is checked whether the accelerator pedal reaches or exceeds a second limiting accelerator pedal position, which can in particular correspond to an (absolute) limiting accelerator pedal angle. Depending on the embodiment variant, the established reaching and/or exceeding of the second limiting accelerator pedal position can be used as a necessary or sufficient condition for meeting the second abort criterion. In other words, it can be provided that the driver can override the emergency braking action in a situation in which the speed limiter and the autonomous emergency braking system are active simultaneously in that they depress the accelerator pedal at least to the second limiting accelerator pedal position. The second limiting accelerator pedal position and the first limiting accelerator pedal position are predefined here so that the accelerator pedal is depressed further in the second limiting accelerator pedal position than in the first limiting accelerator pedal position. In other words, a second limiting accelerator pedal angle, which characterizes the second limiting accelerator pedal position, can be greater than a first limiting accelerator pedal angle, which characterizes the first limiting accelerator pedal position. For example, the first limiting accelerator pedal angle can be at 90% of a maximum possible accelerator pedal angle, which corresponds to a completely depressed state of the accelerator pedal, and the second limiting accelerator pedal angle can be significantly increased in comparison thereto, for example to 99% of the maximum possible accelerator pedal angle.

For example, the second limiting accelerator pedal position can be defined so that the accelerator pedal is depressed further in the second limiting accelerator pedal position than in a third limiting accelerator pedal position, upon the reaching or exceeding of which the speed limiter is overridden. Due to such a selection of the second limiting accelerator pedal position as an abort threshold for the emergency braking action, it cannot come to a situation in which the emergency braking action is inadvertently aborted because the driver, for example, before the emergency braking action has constantly held the accelerator pedal in a position which is just before an abort threshold for the speed limiter, but is already above an abort threshold for the emergency braking function.

Alternatively or additionally to an absolute accelerator pedal position, as described above, the second abort criterion can also relate to a change, in particular over time, of a position of the accelerator pedal.

For example, establishing whether the second abort criterion is met can comprise that it is checked whether a predetermined minimum change of a position of the accelerator pedal takes place. The minimum change can in particular be defined here so that the accelerator pedal is increasingly depressed in this case. The minimum change can thus be defined as a positive change, i.e. an increase of the accelerator pedal angle, as is typical in the case of an acceleration intention of the driver. For example, it can be necessary to meet the second abort criterion for a positive change in the accelerator pedal angle to be detected at least once, thus a pedal actuation in which the accelerator pedal is increasingly depressed.

The change of the accelerator pedal position can be observed, for example, as a time derivative or time gradient of the accelerator pedal angle and can possibly be compared to a minimum gradient corresponding to the minimum change.

According to one refinement, establishing whether the second abort criterion is met can furthermore comprise that it is checked whether a change of the position from a further depressed position to a less depressed position is followed by a change in which the accelerator pedal is increasingly depressed. In other words, it can thus be checked whether initially a negative change of the accelerator pedal angle and then a positive change of the accelerator pedal angle is detected. The respective changes of the accelerator pedal angle or the accelerator pedal position can be checked here as to whether they reach or exceed a respective minimum change, such as the above-mentioned minimum change. For example, a result of such a design of the second abort criterion can be that if the driver consistently drives using an accelerator pedal angle which corresponds to 90% of a maximum settable accelerator pedal angle, an emergency braking action is not aborted. However, if the driver decreases the accelerator pedal angle from 90% of the maximum settable accelerator pedal angle to, for example, 50% of the maximum accelerator pedal angle and then increases it again from 50% to 90% during the emergency braking action, the positive accelerator pedal angle change from 50% to 90% can thus be interpreted as a conscious acceleration intention and the emergency braking action can be aborted. Therefore, only active actions of the driver which express an acceleration intention are assessed as an abort reason for the emergency braking function. In particular, continuously holding the accelerator pedal is not incorrectly assessed here as an acceleration intention or as a conscious action to abort the emergency braking action.

In general, the second abort criterion can be defined so that it weights changes of the position of the accelerator pedal in comparison to the absolute position of the accelerator pedal more strongly than the first abort criterion. This is based on the concept that as a result a driver intention to abort the emergency braking function is to be recognized and that when driving at the speed limit of the limiter, the absolute accelerator pedal position is therefore less informative than with inactive limiter. This is because in the mental model of the driver, the accelerator pedal has no influence with activated limiter. The driver will therefore intuitively perform changes to the position of the accelerator pedal in order to express their possible intention to abort the emergency braking action. For example, in such a situation, the driver would typically initially briefly depress the accelerator pedal less (negative change of the accelerator pedal angle) and then consciously depress it further (positive accelerator pedal angle change). Such a change of the accelerator pedal position can therefore be used as a reliable abort criterion for the emergency braking function.

According to one refinement, the controller can be configured in such a manner that detected accelerator pedal actuations which take place up to a predefined time after the beginning of the emergency braking action are ignored for the purposes of establishing whether the actuation of the accelerator pedal meets the first and/or second abort criterion. The predetermined time during which the accelerator pedal actuations remain unconsidered with regard to an override of the emergency braking function can be in this case, for example, in the range of 100 to 1000 ms, for example 700 ms. This refinement is based on the finding that the driver often inadvertently “gives gas” at the beginning of an autonomous emergency braking action due to the dipping of the vehicle, since their foot briefly depresses the accelerator pedal further due to the inertial force acting thereon. Since this is not an active action here, which expresses an abort intention, it is advantageous to hide accelerator pedal actuations entirely at the beginning of the emergency braking action for the purpose of checking the abort criterion.

A second aspect of the invention is a vehicle, in particular a motor vehicle, having a controller for an autonomous emergency braking system according to the first aspect of the invention.

A third aspect of the invention is a computer-implemented method for controlling an autonomous emergency braking system of a vehicle, comprising the following steps: receiving information about an actuation of an accelerator pedal of the vehicle while an automatic emergency braking action is being executed; establishing on the basis of the information whether the actuation of the accelerator pedal meets an abort criterion; and generating one or more control signals to abort the emergency braking action depending on whether the actuation of the accelerator pedal meets the abort criterion. In this case, a first abort criterion is used as the abort criterion if a speed limiter of the vehicle is not active, and if the speed limiter is active, a second abort criterion different from the first abort criterion is used. The abort criterion used for the emergency braking function thus depends on whether presently a speed limiter of the vehicle is active or not.

The method according to the third aspect of the invention can be able to be carried out by a controller according to the first aspect of the invention. Corresponding thereto, the explanations above and below regarding the controller according to the invention and its possible designs are to be understood analogously for the method according to the invention and vice versa.

The controller according to the invention can comprise, for example, a (data) processing unit, which has at least one processor and is configured to carry out the method according to the third aspect of the invention by the at least one processor. According to some embodiments, this can also be a spatially distributed processing unit (for example, over multiple processors or microcontrollers spaced apart from one another) in this case.

A fourth aspect of the invention is a computer program which comprises commands which, when the computer program is executed by a processing unit, such as a controller according to the first aspect of the invention or a processing unit of a controller according to the first aspect of the invention, cause it to carry out a method according to the third aspect of the invention. The computer program can be divided here into multiple separate subprograms which can each be executed by different processing units (for example, multiple separate processors) possibly spatially remote from one another.

A controller according to the first aspect of the invention or a processing unit of such a controller can be configured (in particular programmed) to execute a computer program according to the fourth aspect of the invention.

A fifth aspect of the invention is a computer-readable storage medium which comprises commands which, when they are executed by a processing unit, cause it to carry out a method according to the third aspect of the invention. In other words, a computer program according to the fourth aspect of the invention can thus be stored on the computer-readable storage medium.

The invention will now be explained in more detail on the basis of exemplary embodiments and with reference to the appended drawings.

### BRIEF DESCRIPTION OF THE DRAWINGS

FIG. 1 schematically illustrates by way of example an autonomous emergency braking system of a vehicle.

FIG. 2 schematically illustrates by way of example steps of a method for controlling an autonomous emergency braking system of a vehicle.

FIG. 3 schematically illustrates by way of example a temporal course of an accelerator pedal actuation to override an emergency braking action.

### DETAILED DESCRIPTION OF THE DRAWINGS

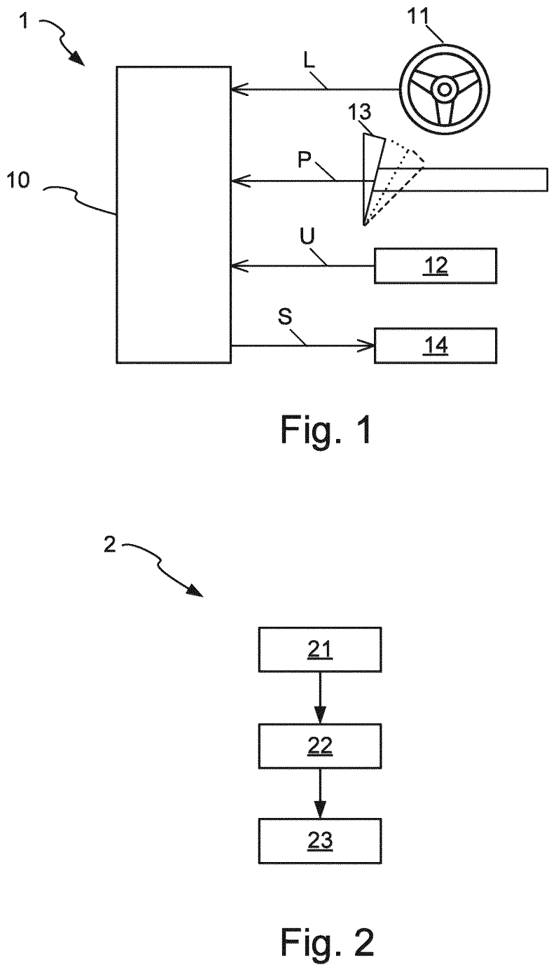

The emergency braking system 1 shown in FIG. 1 comprises a controller 10, which is connected for signaling to a surroundings sensor system 12. The controller 10 is configured here to receive surroundings data from the surroundings sensor system 12, such as camera, radar, and/or lidar data. In addition, the controller 10 is connected for signaling to a steering wheel angle sensor arranged on a steering wheel 11 and/or to a steering angle sensor and is configured to receive steering actuation information L from this sensor or from these sensors. The controller 10 is also connected for signaling to pedal angle sensors, which are arranged on an accelerator pedal 13 and on a brake pedal (not separately shown in FIG. 1) and is configured to receive pedal actuation information P from these sensors. On the basis of the surroundings information U, the steering actuation information L, and the pedal actuation information P, the controller 10 progressively calculates during the journey of the vehicle whether a critical situation exists which makes an autonomous braking intervention necessary. If this is the case, the controller 10 thus generates control signals S to execute an automatic emergency braking action. The control signals S are transmitted from the controller 10 to a braking system 14 of the vehicle. The braking system 14 then executes an emergency braking action of the vehicle.

The driver can override an emergency braking action initiated by the autonomous emergency braking system 1 in particular by actuating the accelerator pedal 13, for example to abort an incorrectly triggered autonomous emergency braking action.

To enable an override of the emergency braking system by the accelerator pedal 13, the controller 10 is configured to carry out steps 21 to 23 of the method shown as a block diagram in FIG. 2: In a step 21, the controller 10 receives information about an actuation of the accelerator pedal 13 (pedal actuation information P) while the automatic emergency braking action is being executed. In a step 22, the processing unit 10 establishes on the basis of the pedal actuation information P whether the actuation of the accelerator pedal 13 meets a predetermined abort criterion. Depending on whether it is established that the actuation of the accelerator pedal 13 meets the abort criterion, the controller 10 then generates one or more control signals S to abort the emergency braking action. The control signals S are output to the braking system 14 and implemented thereby.

The controller 10 is configured to use a first abort criterion as the abort criterion for the emergency braking action if a speed limiter of the vehicle is not active and to use a second abort criterion, which is different from the first abort criterion, if the speed limiter is active, i.e. if the vehicle presently drives in the limiter, so that it does not accelerate above the set limit speed in spite of an accelerator pedal actuation.

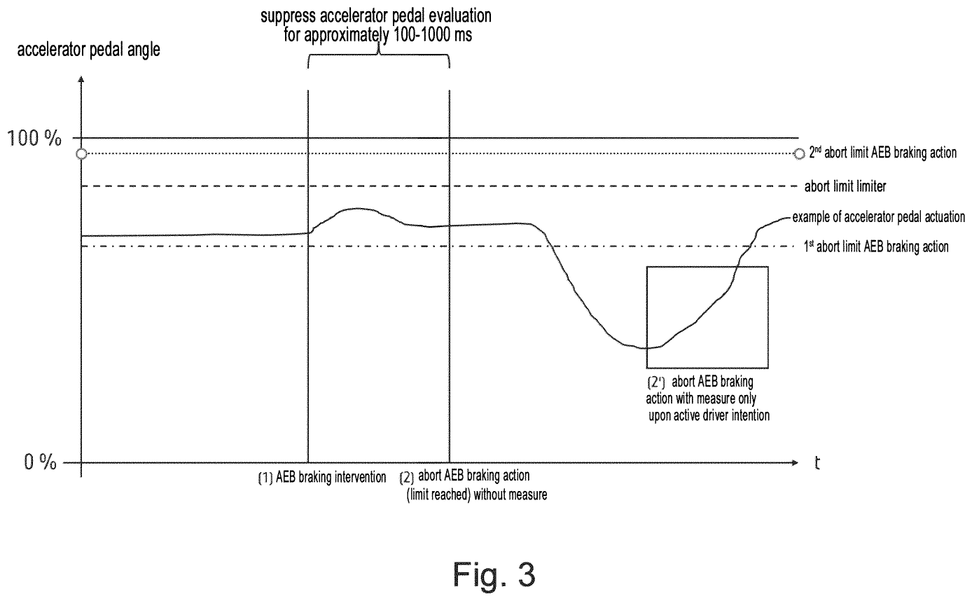

The different abort criteria with and without activated speed limiter are explained hereinafter by way of example on the basis of the diagram in FIG. 3. A temporal course of an accelerator pedal actuation by a driver is shown therein for an exemplary scenario of an emergency braking action. Specifically, a relative accelerator pedal angle is plotted over the time t. In the case of the accelerator pedal angle, 0% corresponds to an accelerator pedal position in which the accelerator pedal is not actuated at all and accordingly is in its idle position. 100% corresponds to a maximally depressed accelerator pedal.

At the beginning of the temporal course shown of the accelerator pedal actuation, the driver holds the accelerator pedal consistently in a position depressed relatively far. The accelerator pedal angle is below a third limiting accelerator pedal position represented by a dashed line here (“abort limit limiter”), upon the reaching or exceeding of which the speed limiter (limiter) would be overridden. The vehicle thus travels with active speed limiter (i.e. “in the limiter”) and accordingly does not accelerate although the accelerator pedal is depressed comparatively far.

After a certain time, an automatic emergency braking action is triggered by the emergency braking system 1 (“(1) AEB braking intervention”). The accelerator pedal angle thereupon increases briefly, since the accelerator pedal is inadvertently temporarily depressed somewhat further due to the sudden braking and the inertial force acting in this case on the foot of the driver. In order that this effect does not result in an inadvertent abort of the emergency braking action, the accelerator pedal actuation is ignored for a predetermined duration in the range of 100 to 1000 ms from the beginning of the emergency braking action for the purpose of establishing whether the abort criterion is met for the emergency braking action. This time interval is marked in FIG. 3 by two vertical lines (“suppression of accelerator pedal evaluation”).

If no special precautions had been provided and a first limiting accelerator pedal angle, upon the reaching or exceeding of which the emergency braking action is aborted normally, i.e. with nonactivated speed limiter, would apply even in the case of an activated speed limiter, in the example shown, the emergency braking action would thus be aborted immediately after the passage of the predetermined time during which the accelerator pedal actuation is ignored (cf. in FIG. 3:“(2) abort AEB braking action (limit reached) without measure”). The reason is that the accelerator pedal angle is greater at this time than the first limiting accelerator pedal angle, which is marked in FIG. 3 by a dot-dash line (“1st abort limit AEB braking action”).

In order to prevent an inadvertent override of the emergency braking function in such a case, in which the accelerator pedal angle at the beginning of an emergency braking action is below an abort limit for the speed limiter, but is above a first abort limit for the emergency braking action, in case of an activated speed limiter, a second abort criterion different from the first abort criterion (for example: accelerator pedal angle exceeds the “1st abort limit AEB braking action”) is provided.

In this case, establishing 22 whether the second abort criterion is met can comprise, for example, that it is checked whether the accelerator pedal 13 reaches or exceeds a second limiting accelerator pedal position. The second limiting accelerator pedal position corresponds to a second limiting accelerator pedal angle, which is shown in the diagram in FIG. 3 as a dotted line (“2nd abort limit AEB braking action”). The second limiting accelerator pedal angle is higher than the first limiting accelerator pedal angle, upon the reaching or exceeding of which the emergency braking would be aborted with nonactivated speed limiter. The second accelerator pedal limiting angle is also higher than the third accelerator pedal limiting angle, upon the reaching or exceeding of which the speed limiter is normally overridden (“abort limit limiter”). For example, the second limiting accelerator pedal angle can be 99% of the maximum settable accelerator pedal angle. In the exemplary scenario according to FIG. 3, however, the second limiting accelerator pedal angle is not reached during the accelerator pedal actuation, so that this abort criterion does not apply.

Alternatively or additionally to the comparison of the absolute accelerator pedal position with the second limiting accelerator pedal angle, as described above, establishing whether the second abort criterion is met can also comprise, however, that it is checked whether a predetermined minimum change of a position of the accelerator pedal 13 takes place. It can be provided here, for example, that it is sufficient to meet the second abort criterion if the accelerator pedal angle reaches or exceeds the second limiting accelerator pedal angle or if a change of the accelerator pedal 13 is established which corresponds to at least the predefined minimum change. The minimum change can be defined here in particular as a positive accelerator pedal angle change, corresponding to an accelerator pedal actuation in which the accelerator pedal 13 is increasingly depressed.

It is also conceivable that it is checked whether a change of the position of the accelerator pedal from a further depressed position to a less depressed position (thus a negative accelerator pedal angle change) is followed by a change of the position of the accelerator pedal 13 in which the accelerator pedal 13 is increasingly depressed (positive change of the accelerator pedal angle). Such a temporal course of an accelerator pedal actuation is illustrated as an example in the diagram in FIG. 3. In this case, a significant negative accelerator pedal angle change initially takes place and then a positive accelerator pedal angle change, again approximately at the level of the initially set accelerator pedal angle. Such a pattern corresponds to a typical accelerator pedal angle actuation of the driver who has mentally internalized, with activated speed limiter, that the absolute accelerator pedal position has little or no influence and therefore will intuitively vary the accelerator pedal position or will “pump” the accelerator pedal 13 in order to express their acceleration intention or their intention to abort the emergency braking action.

In the diagram in FIG. 3, a phase in a positive change over time of the accelerator pedal angle is highlighted by a small box. For example, it can be established in this phase that the (positive) accelerator pedal change corresponds to the predefined minimum change or even exceeds it, whereupon the second abort criterion is considered to be met and the processing unit 10 outputs a control signal S to abort the emergency braking action (“(2′) abort AEB braking action with measure only upon active driver intention”).

As a result, because a pedal actuation necessary to override the emergency braking action with activated speed limiter differs from a pedal actuation necessary to override the emergency braking with nonactivated speed limiter, it can be ensured that an emergency braking action can (only) be overridden in accordance with a driver intention.

1-12. (canceled)

13. A controller for an autonomous emergency braking system of a vehicle, wherein the controller is configured to:
receive information about an actuation of an accelerator pedal of the vehicle while an automatic emergency braking action is being executed;
establish, based on the information, whether the actuation of the accelerator pedal meets an abort criterion; and
abort the automatic emergency braking action in response to establishing that the actuation of the accelerator pedal meets the abort criterion,
wherein, as the abort criterion:
a first abort criterion is used in response to a speed limiter of the vehicle not being active, and
a second abort criterion different from the first abort criterion is used in response to the speed limiter being active.

14. The controller according to claim 13, wherein the controller is configured to:
establish whether the first abort criterion is met by checking whether the accelerator pedal reaches or exceeds a first limiting accelerator pedal position.

15. The controller according to claim 14, wherein the controller is configured to:
establish whether the second abort criterion is met by checking whether the accelerator pedal reaches or exceeds a second limiting accelerator pedal position, wherein the accelerator pedal is depressed further in the second limiting accelerator pedal position than in the first limiting accelerator pedal position.

16. The controller according to claim 15,
wherein the accelerator pedal is depressed further in the second limiting accelerator pedal position than in a third limiting accelerator pedal position, wherein the speed limiter is overridden upon reaching or exceeding the third limiting accelerator pedal position.

17. The controller according to claim 13,
wherein the second abort criterion relates to a change of a position of the accelerator pedal.

18. The controller according to claim 17, wherein the controller is configured to:
establish whether the second abort criterion is met by checking whether a predetermined minimum change in a position of the accelerator pedal takes place.

19. The controller according to claim 18,
wherein the minimum change takes place in such a manner that the accelerator pedal is increasingly depressed.

20. The controller according to claim 17, wherein the controller is configured to:
establish whether the second abort criterion is met by checking whether a change of the position of the accelerator pedal from a position depressed further to a position depressed less is followed by a change in which the accelerator pedal is increasingly depressed.

21. The controller according to claim 13,
wherein accelerator pedal actuations which take place up to a predefined time after a beginning of the automatic emergency braking action are ignored for purposes of establishing whether the actuation of the accelerator pedal meets the abort criterion.

22. A computer-implemented method for controlling an autonomous emergency braking system of a vehicle, comprising:
receiving information about an actuation of an accelerator pedal of the vehicle while an automatic emergency braking action is being executed;
establishing, on a basis of the information, whether the actuation of the accelerator pedal meets an abort criterion; and
generating one or more control signals to abort the automatic emergency braking action depending on whether the actuation of the accelerator pedal meets the abort criterion,
wherein, as the abort criterion:
a first abort criterion is used in response to a speed limiter of the vehicle being not active, and
a second abort criterion different from the first abort criterion is used in response to the speed limiter being active.

23. A non-transitory computer-readable storage medium comprising commands which, when executed by a processing device, cause the processing device to carry out the method according to claim 22.
